(19) United States
(12) Patent Application Publication
(10) Pub. No.: US 2025/0141164 A1
(43) Pub. Date: May 1, 2025

(54) CONNECTION SYSTEM FOR A CABLE

(71) Applicant: Murrelektronik GmbH, Oppenweiler (DE)

(72) Inventors: Olaf PREIN, Lügde-Rischenau (DE); Marco BOSCH, Weilheim a. d. Teck (DE); Heiko FEISST, Schlierbach (DE); Christian KÜBLER, Backnang – Maubach (DE)

(73) Assignee: Murrelektronik GmbH, Oppenweiler (DE)

(21) Appl. No.: 18/923,784

(22) Filed: Oct. 23, 2024

(30) Foreign Application Priority Data
Oct. 27, 2023 (DE) 10 2023 129 761.9
Jun. 6, 2024 (DE) 10 2024 115 858.1

(51) Int. Cl. H01R 24/20; H01R 13/52; H01R 13/533; H01R 13/629; H01R 13/641; H01R 24/86

(52) U.S. Cl. CPC H01R 24/20; H01R 13/521; H01R 13/533; H01R 13/629; H01R 13/641; H01R 24/86

(57) ABSTRACT

The invention relates to a connection system, comprising:
a component for connection to an electrical cable, the component comprising a plurality of contact means for making contact with conductors of the cable, the contact means being electrically conductive,
the electrical cable, in which the conductors are accessible for contacting with the contact means, wherein the conductors are electrically conductive, and wherein the conductors each have an exposed conductor cross-section.

### RELATED APPLICATION SECTION

This application claims the benefit of priority of Germany Patent Application Nos. 10 2024 115 858.1 filed on Jun. 6, 2024 and 10 2023 129 761.9 filed on Oct. 27, 2023, the contents of which are incorporated by reference as if fully set forth herein in their entirety.

### FIELD AND BACKGROUND OF THE INVENTION

The present invention relates to a connection system according to the type defined in more detail in the preamble of claim 1. Furthermore, the invention relates to a cable and a method.

It is known from the state of the art that electrical cables are used pre-assembled during the installation of an electrical system or are only assembled to a desired length in the field. However, the use of pre-assembled cables is inflexible and may be limited by the availability of the corresponding cables. Field assembly, on the other hand, is more flexible, but is often a time-consuming process.

To assemble the cable, the cable may first be stripped and crimped and then connected to a plug connector. A crimping tool, for example, is used to securely connect the plug connector to the conductors of the cable by applying pressure and deformation. A stripping tool may also be used to cut off the outer insulation of the cables without damaging the underlying conductors.

Furthermore, it is known from the state of the art that current Ethernet technology is often too complex and oversized for applications in the Industrial Internet of Things (IIoT). In particular, conventional plug connectors and cables are in many cases less optimal for use at field level. This makes the integration of sensors and other components more difficult, especially due to the cabling requirements and the limited cable length. A simplified Ethernet standard, Single Pair Ethernet (SPE), already offers a solution here through the combination of long cable lengths, compact design and robust cabling.

However, conventional solutions are still very costly when it comes to always providing the right cable length in the field.

It is therefore a task of the present invention to at least partially eliminate the disadvantages described above. In particular, it is the task of the present invention to further simplify the installation technology and to provide the correct cable for an application in an improved manner. In particular, an improved, more flexible and/or simpler connection technology that may be used in the field is to be provided.

### SUMMARY OF THE INVENTION

The object of the invention is a connection system having the features of claim 1 and a cable having the features of claim 27. Further features and details of the invention are apparent from the respective subclaims, the description and the drawings. Features and details that are described in connection with the connection system according to the invention naturally also apply in connection with the cable according to the invention and the method according to the invention, and vice versa, so that reference is or may always be made reciprocally to the individual aspects of the invention with regard to the disclosure.

The object of the invention is in particular a connection system, preferably for a cable and specifically for establishing a connection between the cable and a component. Accordingly, the connection system may comprise the component and the cable and optionally further elements such as a guide device. The cable may be designed as an electrical cable and the component as an electrical component. Alternatively or additionally, the cable and component may also be designed to conduct other media such as liquids or air.

The component may be intended for connection to the cable. For example, the component is a plug connector or an actuator or a sensor or a module such as a fieldbus module. The component may comprise one or more contact means for making contact with an associated conductor of the cable. In other words, if there are several conductors of the cable, these may each be assigned to one of the contact means in order to connect each of the conductors to one of the contact means. The assignment or affiliation may, for example, be determined according to a predefined (electrical) assignment. If the component is designed as an electrical component, the contact means are electrically conductive. If the cable is designed as an electrical cable, the conductors may be designed to be electrically conductive.

The cable may be designed in such a way that the respective conductor of the cable is accessible for contacting with the associated contact means. In particular, this means that the respective conductor is accessible from the outside (i.e. outside the cable), in particular that it may be contacted electrically from the outside without further measures such as stripping. This is made possible in particular by the fact that the respective conductor (for contacting) has an exposed conductor cross-section. In the case of several conductors of the cable, several exposed conductor cross-sections of these conductors may thus be accessible on one contact surface of the cable.

The connection system may also be designed to make contact between the respective contact means and the associated conductor in an axial direction of the cable or conductor. In other words, the connection system may in particular be designed in such a way that contacting is possible by a relative movement of the respective contact means and the associated conductor parallel to the axial direction of the cable or conductor. Furthermore, in this way the respective contact means may be electrically connected directly to the exposed conductor cross-section of the associated conductor, e.g. pierced through this conductor cross-section. This has the advantage that the connection may be made more easily and with less effort. This also has the advantage that the cable may simply be cut to the desired length and connected, thus eliminating the need for more complex cable assembly.

It is conceivable that the respective contact means is electrically connected to a conductor to be contacted (i.e. the associated conductor) by piercing the contact means through the exposed conductor cross-section of the conductor to be contacted. This “piercing” makes it possible to establish an electrical connection quickly and reliably.

In a further possibility, it may be provided that the respective contact means has a tip and/or is needle-shaped. This enables the conductor or conductors to be contacted by piercing the contact means on and/or through the exposed conductor cross-section of the conductor or the contact means on and/or through the exposed conductor cross-sections in the axial direction.

Preferably, within the scope of the invention, it may be provided that the conductor or conductors are each formed as a strand. The respective strand may have flexible single wires in order to electrically conductively surround the contact means pierced through the respective conductor cross-section. Each conductor may thus have several single wires, whereby the respective contact means may be surrounded by the single wires of the conductor in which it was pierced. This makes piercing much easier, as the conductor is easier to penetrate due to the flexible single wires. Furthermore, the electrical connection may be made much more reliably.

It is also advantageous if the respective contact means is designed to be inserted, preferably pierced, into the conductor at and/or through the exposed conductor cross-section of the contacting (associated) conductor. In other words, each of the contact means may be inserted into a conductor cross-section provided for this purpose. Furthermore, the respective conductor may be at least partially surrounded by an insulating sheath with its (respectively) exposed conductor cross-section and the (respectively) inserted, preferably pierced, contact means. It is therefore not necessary to strip the conductor—i.e. remove the insulating sheath—in order to make the connection. This simplifies and speeds up the installation of the cable.

It is also conceivable within the scope of the invention that a contact surface is provided on the cable, at which the conductor or conductors are accessible for contacting with the contact means. The contact surface may lie in a cutting plane of the cable. In other words, the contact surface may be located at the plane at which the cable was cut. At the contact surface or cutting plane, the conductor or conductors may be adjacent to or protrude outwards from an interior of the cable and be visible from outside the cable. Furthermore, the conductor or conductors preferably protrude from the contact surface or are located in a recessed position in the cable. It is also conceivable that the respective exposed conductor cross-section is also located in the cutting plane. This provides a structure that is easy to connect and allows the cable to be inherently designed as a plug or socket.

A further advantage within the scope of the invention may be achieved if the respective conductor forms a line with a surrounding insulating sheath, whereby the resulting line or lines may protrude from the contact surface. Further, the respective protruding line may be only partially surrounded by a cable sheath of the cable or may be at least partially freed from the cable sheath of the cable. It is also possible for the respective protruding conductor and/or the respective exposed conductor cross-section to be completely or partially surrounded by the insulating sheath. In this case, the contact surface may be formed by a cut surface of the cable sheath of the cable. Since only part of the cable sheath is removed, but not each individual insulating sheath of the conductors, the effort involved may be significantly reduced.

The connection between the component and the cable may be made directly at a contacting surface and in particular a cut surface of the cable. The contact surface may designate a surface and, in particular, a cross-section through the cable at which the respective conductor of the cable is or may become accessible from the outside for contacting with the contact means of the component. The surface may be arranged orthogonally to the axial direction of the cable. The respective conductor of the cable may directly adjoin an outer area of the cable at the contact surface and thus be connected to the contact means of the component without cutting through the sheath and/or insulation of the cable. The respective conductor may also be separated at the contact surface in alignment with the contact surface. The cable may be designed to provide such a contact surface after the cable has been cut to size.

The cable may be formed in such a way, preferably after cutting the cable to size, that the respective conductor of the cable is or becomes accessible for contacting with an associated contact means. In particular, this means that the respective conductor is or becomes accessible from the outside (i.e. outside the cable), in particular that it may be contacted electrically from the outside without further measures such as stripping. This is made possible in particular by the fact that the respective conductor (for contacting) has an exposed conductor cross-section, in particular as soon as the cable has been cut to size. Alternatively or additionally, the cable may also have the contact surface and/or the accessible conductor in its original state (e.g. as delivered without being cut to size).

It is possible that the cut cable has a plug-in structure, in particular provided by the coding and/or connection structure. In other words, the cable may be designed to have a plug-in structure on the cut surface even after it has been cut to length. This has the advantage that the cable may be connected directly to the component after it has been cut to a desired length. This is made possible in particular by the fact that the plug-in structure is provided continuously or repeatedly in the axial direction along the cable. As such, and therefore immediately after cutting, the cut cable may already have the necessary structure on its cut surface to enable a direct connection of the component.

It is also conceivable within the scope of the invention that (at least) one contact surface is provided on the cable, at which the respective conductor is accessible for contacting with the associated contact means, and at which the coding is preferably provided. The contact surface may lie in the cutting plane of the cable. In other words, the contact surface may be located at the plane at which the cable was cut.

The cable may be designed to have a contact surface, preferably with the coding, on the cut surface after cutting. The conductor or conductors may adjoin or protrude outwards from an interior of the cable at the contact surface or cutting plane and be visible from outside the cable. Furthermore, the respective conductor preferably protrudes from the contact surface or is located in a recessed position in the cable. It is also conceivable that a respective exposed conductor cross-section is also located in the cutting plane. This provides an easy-to-connect structure that allows the cable to be inherently designed as a plug or socket.

A further advantage may be achieved within the scope of the invention if a geometric profile, in particular a spatial shape and/or contour, extends in the axial direction of the cable. The profile may define a guide cavity for a guide means, and preferably for a guide pin of the component, to mechanically guide the contacting in the axial direction of the cable. This may serve to guide the insertion of the contact means or contact means into the conductor(s) in the axial direction of the cable or conductors, thereby further simplifying the making of the contact and avoiding errors in the contacting. Furthermore, the guide cavity may be designed particularly preferably for transferring a fluid, in particular for transferring a medium such as air or a liquid.

Preferably, it may be provided that the connection system has a guide device. The guide device may be designed separately from the cable and the component. The guide device may optionally be movably connected to the cable and/or the component, e.g. via a strap or a loop. Alternatively, the guide device may also be formed as an (e.g. integral) part of the cable or the component. In general, the guide device may be designed to mechanically guide the contacting in the axial direction of the cable or the respective conductor, and preferably to guide the conductor, in particular the lines, and/or the contact means for contacting in the axial direction of the cable. Thus, the guide device is a tool to simplify the contacting without, for example, stripping and/or crimping.

For example, it may be provided that the guide device has a guide housing with a guide structure, preferably in the form of openings in the guide housing, in order to provide the mechanical guide for the respective conductor, in particular lines, and/or contact means. The guide structure for holding the conductor, in particular conductors, may be formed on one (first) side of the guide housing. On another (second) side of the guide housing, preferably opposite and/or facing away from the guide device (the first side) in the axial direction, the guide structure may be designed to accommodate the contact means. This may serve to provide the contacting in an interior space of the guide housing of the guide device and/or to mechanically guide an insertion of the contact means into the conductors in the axial direction of the cable or the conductors for contacting. This makes the connection easier and safer. If the contacting is provided in the interior of the guide device, mechanical protection and/or a seal may also be provided.

It may optionally be possible that the (multiple) conductors each form a line with a surrounding insulating sheath, whereby the lines are color-coded, in particular by a different color of the insulating sheaths. A corresponding counter-coding may be provided on the guide device in order to assign a guide structure and preferably openings of the guide housing to the corresponding conductors by color, e.g. by applying the same colors to indicate openings associated with the conductors. This allows the conductors to be assigned to the component more safely and reliably.

A further advantage may be achieved within the scope of the invention if at least one coding is spatially formed on the cable and/or on the guide device in order to specify a specific arrangement and assignment of the contact means of the component with the electrical conductors of the cable. For example, it may be the case that the conductors have specific functions and must therefore be correctly assigned to the contact means. The assignment may be provided, for example, by color coding, but alternatively or additionally also by mechanical coding. The coding is formed, for example, on the cable itself, e.g. by a specially shaped cavity. It is also conceivable that the guide device has the coding. For this purpose, the guide device is designed as a grommet, for example, which may be subsequently attached to the cable.

The at least one coding may comprise a mechanical and/or geometric coding of the cable and/or the guide device, in which a geometric profile, in particular a spatial shape and/or contour, extends in the axial direction of the cable and/or the guide device. Preferably, the profile may define a guide cavity for a guide means and preferably for a guide pin of the component, so that a specific orientation of the component is predetermined for the connection. This may further enable the connection of the component to be blocked in the event of a deviation from the specific orientation, for example by the housing of the guide device or by a part of the cable.

Furthermore, the at least one coding may in particular comprise a geometric and/or extruded profile of the cable and/or the guide device, in particular in the form of a grommet, and/or a tube, wherein the at least one coding in particular additionally comprises an electrical coding and/or color coding, in which a systematic arrangement of the electrical conductors of the cable is provided, so that a specific assignment of the electrical contact means of the component is predetermined for the connection.

The at least one coding may be formed by means of a rotationally symmetry-free cross-section of the cable, in particular by a rotationally symmetry-free inner and/or outer contour of the cable. This may ensure that the cable may only be electrically connected to the component in a position that corresponds to a distinct assignment of the contact means to the electrical conductors of the cable. The rotationally symmetry-free outer contour may be formed by means of a cable sheath or outer circumference of the cable, preferably in that the cable has a cross-section with a circular basic shape and at least one recess, in particular a groove, and/or at least one elevation, in particular a bead. Preferably, the recess or elevation, in particular the bead, is the coding. Alternatively, the outer contour may be a free form or a polygonal shape. The inner contour may be formed by means of a circular fluid line, which forms the coding due to its position and/or shape within the cross-section of the cable. Alternatively, the fluid line may have a free form or the shape of a polygon. Due to the coding, the component with the coding may be regarded as a key and the component with the matching counter-coding as a lock. This may ensure the intended specific contact between the conductors and the contact means.

Particularly preferably, the guide cavity may be designed to transfer a fluid, in particular to transfer a medium such as air or a liquid.

Furthermore, it may be provided that the conductors of the cable are each formed as strands in order to form a receptacle for inserting the contact means of the component, preferably for piercing the contact means in the form of a contacting tip into the strands in the axial direction of the cable.

The guide device may be provided between the cable and the component in order to guide the insertion and preferably piercing with a predetermined arrangement and assignment of the contact means of the component with the conductors of the cable, in particular to guide them linearly. A complementary counter-coding of the component may be provided for the coding on the cable and/or the guide device in order to predetermine the guide and preferably an orientation of the cable in relation to the component.

It is also advantageous if the component and/or a guide device is in direct contact with the contact surface in the connected state, whereby the contact means of the component contact the conductors of the cable and are preferably incorporated therein, preferably pierced. In the connected state, a part of the component and/or the guide device may seal the contact surface and/or mechanically lock it and/or provide anti-twist protection. For this purpose, for example, a protruding housing part or a sealing means or the like is provided on the component or guide device.

The electrical conductors may preferably only and/or directly extend to and/or adjoin a or the contacting surface of the cable, preferably in order to enable piercing of the contact means, in particular in the form of contacting tips and/or piercing means, into the electrical conductors at the contacting surface, wherein the contact surface preferably extends transversely, in particular perpendicularly, to the direction in which the cable extends, and wherein in particular the contact surface may form a cut surface of the cable, at which the cable has preferably been shortened to a desired length, and/or a cable end of the cable. Preferably, the contact surface may be formed by a cut at any point along the extension of the cable, in particular if the coding extends over the entire length of the cable. Preferably, the contact means are designed in such a way that it is only possible to pierce the electrical conductors of the cable by means of the contact means, in particular without cutting.

The electrical conductors of the cable may be twisted together, in particular in the form of one or more twisted pairs, twisted threes or twisted fours, wherein the at least one coding has a continuous course along the length of the cable and a course matched to the twisting such that at any point of the cable along the length of the cable the at least one coding and the electrical conductors may have the same relative position, in particular in a plane transverse, preferably perpendicular, to the direction in which the cable extends. In other words, the coding on the cable sheath may have a continuous helical course in the direction in which the cable extends, preferably with a constant pitch, which is matched in particular to the twisting. The coding may be in the form of a recess, in particular a notch or groove, or an elevation, in particular a shoulder or bead. The twisting may reduce electromagnetic interference. By twisting the conductors, induced electromagnetic fields largely cancel each other out, reducing susceptibility to interference. However, this changes the position of the conductors along the length of the cable, making contact between the contact means of the component and the conductors of the cable more difficult. By means of the coding and the defined, constant relative position of the coding to the conductors along the cable, this problem may be solved and the intended contacting between the contact means of the component and the corresponding conductors of the cable may be made possible at any point of the cable, as the coding may have a continuous course that is matched to the twisting. The various strandings may be spaced apart and/or evenly distributed in the cross-section of the cable. If the cable has a fluid line, it is preferred if the strandings are arranged evenly around the fluid line, preferably in order to achieve uniform cooling of the conductors or the strandings.

The cable may have a fluid line, in particular a liquid line or gas line, wherein in particular the at least one coding may be formed partially or only by means of the fluid line, wherein the electrical conductors, in particular the stranding or strandings, surround the fluid line along the extension of the cable in order preferably to ensure uniform cooling of the conductors by means of the fluid which may be conducted through the fluid line, wherein the component may have a fluid channel which may be connected in a fluid-transmitting manner to the fluid line of the cable and may in particular form a counter-coding partially or only. Preferably, the fluid conduit contributes to the coding by the shape of its cross-section, in particular transverse or perpendicular to the direction in which the cable extends, and/or by its position within the cable cross-section, in particular transverse or perpendicular to the direction in which the cable extends. Contributing to the coding may mean, for example, that a geometry of the cable sheath or the outer contour of the cable also contributes to the coding. In other words, a geometry of the cable sheath or the outer contour of the cable together with the fluid line, in particular the shape and/or position of the fluid line, may form the coding. Alternatively, preferably only the fluid line forms the coding by the shape of its cross-section, in particular transverse or perpendicular to the direction in which the cable extends, and/or by its position within the cable cross-section, in particular transverse or perpendicular to the direction in which the cable extends.

The cable may have along its extension on its outer circumference, preferably at regular intervals from one another, strain relief contours, particularly preferably in the form of circumferential recesses, in particular grooves or indentations, or elevations, in particular beads or steps, preferably for a heat-shrink tubing or a strain relief, and wherein the component may have a strain relief, in particular a heat-shrink tubing designed as strain relief, which is preferably attached to the component, for the cable, which cooperates with the strain relief contour of the cable in such a way that the cable is strain-relieved, in particular by the strain relief forming a form-fit with the strain relief contour of the cable, preferably by the strain relief engaging behind the strain relief contour or engaging in the strain relief contour. Preferably, the strain relief is designed in such a way that the strain relief pretensions the cable against the component, preferably in the direction of extension of the cable and/or in the direction of contacting. Furthermore, it may be preferred that the strain relief is designed to engage in the recess or to engage behind the elevation, in particular as seen from the component. In other words, the strain relief may engage behind the elevation. Furthermore, the strain relief may comprise gripping arms for engaging or gripping behind. The strain relief may be formed of plastic and/or integral with the component. The strain relief may also be adjustable, so that a pretension of the cable against the component may be adjusted. The pretension may be adjustable in steps or continuously. Preferably, the strain relief may be designed in such a way that it creates a strain-relieving connection with the strain relief contour during the contacting movement to establish the electrical connection between the cable and the component.

The multiple contact means, in particular the design and/or arrangement and/or dimensioning of the multiple contact means, may be designed for the electrical conductors, in particular the dimensioning and/or the course of the electrical conductors and/or the arrangement of the electrical conductors on the contact surface, in such a way that electrical contacting of multiple electrical conductors by means of only one of the contact means, in particular by one of the contact means electrically contacting a first electrical conductor in the contact surface and another electrical conductor in the direction of extension of the cable behind or next to the first electrical conductor, preferably due to the twisting of the electrical conductors, is excluded. In this way, incorrect contacting, i.e. unintentional contacting of several conductors by means of a single contact means, is avoided.

The contact means may lead electrically to electrical contact conductors of a plug assembly or socket assembly of the component, whereby the position and/or arrangement and/or assignment and/or dimensioning of the electrical contact conductors differs from that of the contact means, in particular on the contact surface. Preferably, a plug with such a plug assembly or a socket with such a socket assembly may be formed on the component. The course of the guide from the contact means to the contact conductors of the plug or the socket may preferably not be straight, but at least at one point of the course angled, preferably vertical, or curved, whereby the plug or the socket is formed on a side of the component that runs transverse or perpendicular to the insertion direction of the cable or to the contacting direction. The plug may be designed to establish an electrical and/or form-fit connection with a socket. The socket may be designed to establish an electrical and/or form-fit connection with a plug. Alternatively, the plug or the socket may be formed on a side of the component that faces away from the side of the component on which the cable may make electrical contact with the contact means. In addition, the course of the guide from the contact means to the contact conductors of the plug or socket is designed in such a way that the arrangement and/or assignment of the electrical conductors of the plug or socket differs from that of the contact means. For example, an electrical connection may be made from a small cable cross-section of a cable to a large plug assembly or socket assembly. Preferably, at least two contact conductors of the socket assembly or the plug assembly have a greater or smaller distance to each other than the electrical conductors of the cable have to each other in the cable cross-section.

An electrical connection may preferably be established between the cable and the component, in particular by the contact means being pierced into associated conductors, the connection system comprising a seal, in particular a material-fit and/or force-fit and/or form-fit seal, which seals the connection and in particular a cable section adjacent to the connection from an environment of the connection system, in particular in accordance with IP20 or IP67, which seals the connection and in particular a cable section adjacent to the connection from an environment of the connection system, in particular in accordance with IP20 or IP67, wherein the seal may preferably, in particular in the case of a form-fit seal, be formed by means of a heat-shrink tubing or the heat-shrink tubing which forms the strain relief.

The seal may preferably be formed by means of a sealing compound, in particular adhesive or potting compound, whereby, in particular in the direction of extension of the cable and/or perpendicular to the direction of extension of the cable, a sealing chamber may be formed between the cable, in particular the contact surface of the cable, and the component for receiving the sealing compound, in which the sealing compound is located and preferably completely fills the sealing chamber, wherein the sealing chamber preferably has a filler opening for the sealing compound, which is in particular closed by the sealing compound, wherein the sealing chamber preferably has an outlet opening for the sealing compound, which is in particular closed by the sealing compound, wherein in particular a section of the component delimiting the sealing chamber may be formed from a transparent material so that the degree to which the sealing chamber is filled with the sealing compound may be determined optically. The sealing compound may be filled into the sealed chamber in a liquid state by means of the filler opening. By means of the outlet opening, excess sealing compound filled in may escape from the sealed chamber in a liquid state, making it possible to determine whether the sealing compound has been evenly distributed in the sealed chamber. The sealing compound is preferably curable and/or electrically insulating. Closing the openings with the sealing compound prevents foreign bodies or moisture from entering the sealed chamber.

The seal may be formed by means of a released content of a microencapsulation, in particular of the cable or the component. The contents of the microencapsulation may preferably have been released by means of heat supply, radiation, in particular light supply, preferably in the form of ultraviolet light, contact with an activation substance or light supply in combination with moisture.

The seal may seal and/or electrically insulate a transition from the fluid line to the fluid channel from the contact points, which may be formed by means of contacting the conductors with the contact means on the contact surface, in a fluid-tight manner, and/or whereby the seal electrically insulates and/or seals the contact points, which may be formed by means of contacting the conductors with the contact means on the contact surface, from one another. In this way, leakage of the fluid or a malfunction is prevented.

The cable may be attached to the component by means of a force-fit and/or form-fit and/or material-fit connection. The strain relief may also be provided and/or dimensioned and/or designed for this purpose.

The connection system may comprise an insertion mechanism, in particular a screw mechanism, a lever mechanism or a plug-in mechanism, to perform the contacting movement, the insertion mechanism preferably being designed to move the cable towards the component during the contacting movement, the connection system or the insertion mechanism preferably comprising an adjusting mechanism, to adjust a predetermined depth of penetration of the contact means into the conductor at the insertion mechanism, preferably depending on a cable type of the cable and/or continuously and/or in several predefined steps, wherein the connection system or the insertion mechanism preferably comprises an indexing or indexing device which is adapted to index the current depth of penetration for a user during the contacting movement.

Preferably, the screw mechanism is designed as a union nut or comprises a union nut that establishes the electrical connection when screwed to the component. A lever of the lever mechanism may preferably be mounted on the component. Actuation of the lever may cause the contacting movement. Preferably, the component comprises a thread, for example an M8 or M12 thread, preferably as an external thread, and the union nut comprises a mating thread, preferably an internal thread.

The insertion mechanism may include a gripper, for example. The insertion mechanism or gripper may be part of the component, attached to the component or separate to the component. The gripper may grip the cable or a cable end section, preferably by the cable or cable end section being clamped or held by the gripper. Preferably, the gripper interacts with the strain relief contour and/or the coding of the cable for this purpose, preferably by the gripper gripping behind the raised portion or engaging in the recess. Preferably, the gripper has the counter-coding. In other words, the cable may only be gripped in the intended orientation by means of the gripper in order to establish an intended electrical connection between the cable and the component, in particular between the electrical conductors of the cable and the contact means of the component.

Preferably, the insertion mechanism may be used not only to establish the electrical connection, but also to establish the necessary surface pressure for a sealing element, in particular an elastomer seal, on the component. The seal may be arranged in such a way that it is in physical contact with the contact surface when the electrical connection is made. The seal may have been produced by means of a multi-component injection molding process during the manufacture of the component. The seal may seal the transition and/or the fluid conduit and/or the fluid channel from the contact points, between the electrical conductors and the contact means, and/or seal the contact surface from an environment of the connection system. By means of the insertion mechanism, the cable, which is held and/or retainable by the gripper, may be moved towards the component, preferably to establish the electrical connection between the cable and the component, in particular between the electrical conductors of the cable and the contact means. The insertion mechanism may be designed so that the contact means may only be contacted by piercing the electrical conductors of the cable at the contact surface.

The indexing may be designed as a scale or as acoustic and/or haptic feedback for the user. For example, latching noises of a latching mechanism due to the contacting movement may trigger such acoustic feedback. It is also conceivable that engagements of a or the latching mechanism during the contacting movement generate the haptic feedback. The scale may be formed on the component for this purpose, while preferably the insertion mechanism, in particular the screw mechanism, lever mechanism or plug-in mechanism, may act as a pointer to the scale.

The adjusting mechanism may be designed as an adjustable movement limiter for the insertion mechanism, in particular a screw mechanism, lever mechanism or plug-in mechanism, which preferably limits the maximum depth of penetration or the maximum depth of insertion of the contact means into the conductor. The adjusting mechanism may, for example, be adjustable by means of a screw or a union nut and/or rotary movement. Preferably, the insertion mechanism has a movement converter which may be designed in such a way that an actuating movement, in particular pushing movement or rotary movement or pivoting movement, is converted or may be converted into a contacting movement.

A guide device as described above with further details is also protected.

Another object of the invention is a cable for connection to a component, the cable having one or more electrical conductors, the conductors each having an exposed conductor cross-section for contacting them with contact means of the component. Furthermore, the cable may be designed to provide the contacting with a (relative) movement of the conductors and the contact means parallel to one another in an axial direction of the cable in order to electrically connect the contact means directly to the exposed conductor cross-sections. The cable according to the invention thus has the same advantages as those described in detail with reference to a connection system according to the invention. Furthermore, the cable may be designed in accordance with a connection system according to the invention.

Another object of the invention is a method for producing a connection of a cable to a component. According to a method step, a connection system comprising a cable and a component may be provided. The cable may have one or more electrical conductors. A respective conductor cross-section of the conductors may be exposed and accessible from the outside. The component may also comprise one or more contact means for contacting the conductors of the cable. According to a further method step, the contact means may be inserted into the conductors in the axial direction of the cable through the exposed conductor cross-sections in order to establish contact between the contact means and the conductors. The method according to the invention thus has the same advantages as those described in detail with reference to a connection system according to the invention. A connection system according to the invention may also be used in the method according to the invention. Furthermore, it is optionally provided that the conductors each form a line with a surrounding insulating sheath, wherein the cable is provided by cutting it to a desired length without stripping the insulation from the conductors or lines, and wherein the insertion of the contact means is carried out without first stripping the insulation from the conductors.

It is also possible for the cable to be designed as a power or data or hybrid cable. As a hybrid cable, the individual cable may be used for both energy and data transmission, for example. For example, one or more data lines and one or more power lines are provided for this purpose. The respective data and/or energy line may have an electrical conductor which is surrounded by a sheath, in particular an insulating sheath or shielding. The shielding may be made of an electrically conductive material, for example to shield against electromagnetic interference. Materials such as copper or aluminum may be used here. On the other hand, the insulating sheath may be made of an electrically insulating material. Materials such as ceramic, glass or plastic may be used here. The respective data line may be designed as an electrical or optical data line and preferably as a fieldbus and/or Ethernet line.

The cable and/or component and/or connection system may be designed for Single Pair Ethernet (SPE). In contrast to conventional Ethernet, which usually has four wire pairs or conductor pairs per cable, SPE reduces the need for cables, resulting in compact and cost-effective connections. Such a cable preferably has only one pair of wires or only one pair of conductors.

The cable may preferably comprise only one wire pair or conductor pair.

The cable may preferably comprise a twisted pair of wires or conductors. The single wire or conductor pair may be designed to transmit data as well as electrical current or voltage, preferably over distances of up to 1000 meters and/or at a maximum data transmission speed of 10 Mbit/s, 100 Mbit/s or 1 Gbit/s. Furthermore, the cable may be designed to supply an end device with electrical current or voltage in accordance with Power over Data Line (PoDL) and transmit data at the same time. Preferably, the cable and/or the component and/or the connection system may be used or be suitable for use in Industry 4.0, Internet of Things (IoT), the automotive industry or building automation applications. The conductor pair or the wire pair preferably comprises or consists of copper or a copper alloy. Preferably, the cable corresponds to a single pair Ethernet cable according to IEEE 802.3bw, preferably in the validity of this standard on 27.09.2024, in particular in the Federal Republic of Germany. Preferably, the cable may be designed for full-duplex communication.

The component may preferably be a Single Pair Ethernet plug connector (SPE plug connector), in particular in accordance with the IEC 63171 standard, preferably in accordance with the status of 27.09.2024, in particular with effect for the Federal Republic of Germany. Particularly preferably, the component may be designed as a plug connector or circular plug connector with an M8 or M12 thread. The plug assembly or the socket assembly of such a plug connector may have a thread for fastening, in particular to an electrical device or sensor. Furthermore, the cable and/or the component and/or the connection system may be designed to transmit a maximum power of 50 or 60 watts.

It is preferred for conductors to be the conductors of the cable, unless otherwise specified. In other words, they may preferably only be conductors of the plug assembly or socket assembly if it is explicitly stated that they are the conductors of the plug assembly or socket assembly.

In principle, two interacting codings may be referred to as coding and counter-coding.

Furthermore, it may be provided that a recurring marking is provided which indicates the depth of penetration of the electrical contact means, preferably in the form of piercing means. The marking may, for example, be provided on the outside of a cable sheath, e.g. printed on.

The marking may be repeated at fixed intervals in the longitudinal direction of the cable in order to obtain an indication of the depth at which the contact means have been correctly inserted, starting from the cut surface, after the cable has been cut. This makes the connection even simpler and more reliable. The marking may also help with the orientation of the cable for the connection.

The connection system according to the invention may have a strain relief that ensures that the connection between the cable and the component is not accidentally disconnected, in particular that the component is not accidentally pulled out of the cable. The strain relief may be provided by a mechanical locking mechanism which, when the connection is made, cuts into the cable sheath of the cable with a form-fit and/or provides a force-fit clamping with the cable sheath and/or the conductors of the cable. This holds the cable firmly to the component and prevents unintentional disconnection. Accordingly, strain relief may be provided as a function or device of the connection system that serves to fix and protect the cable with the component and prevent the cable connection from being damaged by tensile loads.

If the connection needs to be released again, this may be done using an unlocking mechanism—preferably without tools. The connection technology required for this on the component side may, for example, be integrated directly on a printed circuit board of the component or in a plug of the component. It is also possible for the tool-free unlocking mechanism to be actuated by a simple hand movement, which further simplifies operation of the component. For this purpose, the tool-free unlocking mechanism may have, for example, an unlocking tab or an unlocking button, which is formed on the housing of the component to enable easy unlocking without tools. The locking mechanism may be realized by a latching device, which is activated by a rotation or pressure on a certain area of the component. The latching device may have one or more latching lugs that engage in corresponding recesses or cut-outs. The unlocking mechanism may then be realized by an unlocking button or an unlocking lever, which releases the latching device by a simple actuation and releases the connection. Alternatively, the release mechanism may be realized by a strain relief that is released by a simple twist or pressure on a specific point of the cable or component. This releases the connection and the cable may be removed.

### BRIEF DESCRIPTION OF SEVERAL VIEWS OF THE DRAWINGS

Further advantages, features and details of the invention are apparent from the following description, in which embodiments of the invention are described in detail with reference to the drawings. The features mentioned in the claims and in the description may be essential to the invention individually or in any combination. The drawings showing:

FIG. 1 Variants of cables and components according to embodiments of the invention, each in a sectional view.

FIG. 2 Parts of components according to embodiments of the invention, each in a sectional view.

FIG. 3 Various conductors of cables according to embodiments of the invention, each in a perspective view.

FIG. 4 a perspective view of a contacting or cut surface of cables according to embodiments of the invention.

FIG. 5 a perspective view of a contacting side of components according to embodiments of the invention.

FIG. 6 a perspective view of a component according to embodiments of the invention.

FIG. 7 a perspective view of a component according to embodiments of the invention.

FIG. 8 a sectional view of a cable and a component connected thereto according to embodiments of the invention.

FIG. 9 a perspective view of a contacting or cut surface of a cable according to embodiments of the invention.

FIG. 10 a top view of a cable according to embodiments of the invention.

FIG. 11 a method according to embodiments of the invention.

FIG. 12 a perspective view of a guide device according to embodiments of the invention.

FIG. 13A perspective view of a cable according to embodiments of the invention.

FIG. 14A further perspective view of a cable according to embodiments of the invention.

FIG. 15A schematic representation of an insertion mechanism according to embodiments of the invention.

FIG. 16A further schematic representation of parts of an insertion mechanism according to embodiments of the invention.

FIG. 17 Another schematic representation of an embodiment of a connection system.

FIG. 18a Another schematic representation of an embodiment of a component.

FIG. 18b Another schematic representation of an embodiment of a component.

FIG. 19a Another schematic representation of an embodiment of a connection system with a seal

FIG. 19b Another schematic representation of an embodiment of a connection system with a seal.

FIG. 19c Another schematic representation of an embodiment of a connection system with a seal.

### DESCRIPTION OF SPECIFIC EMBODIMENTS OF THE INVENTION

In the following figures, the identical reference symbols are used for the same technical features, even for different embodiments.

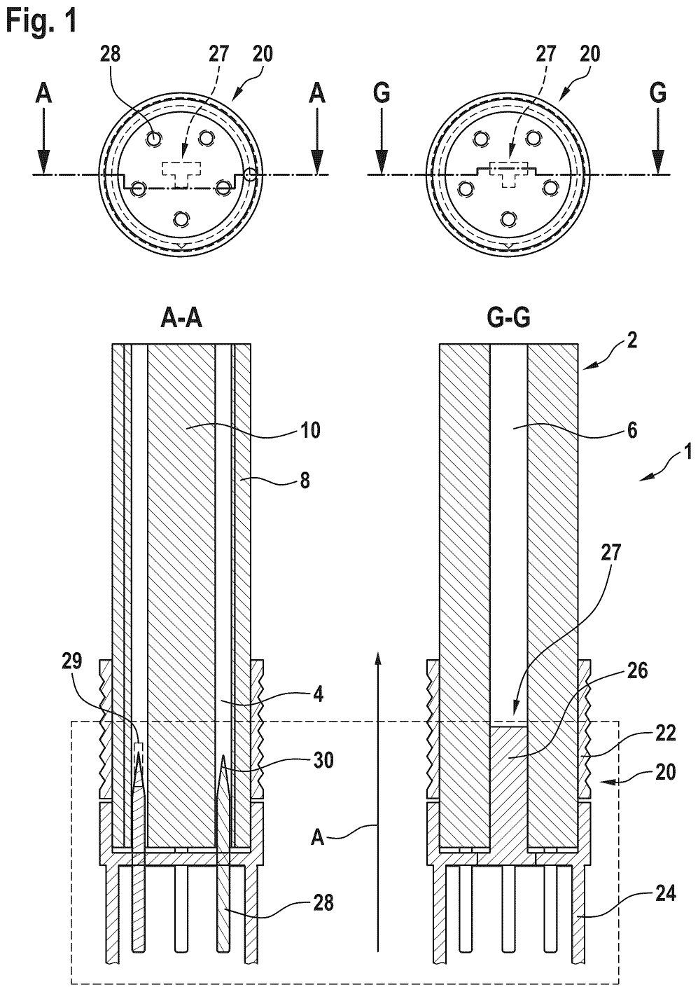

FIGS. 1 to 10 schematically illustrate embodiments of the invention. Specifically, variants of an electrical cable 2 are shown, which is used to connect to an electrical component 20. The cable 2 may have at least one electrical conductor 4 for this purpose. Furthermore, a connection system 1 according to embodiments of the invention is illustrated, which may comprise the cable 2 and the component 20. The sectional planes A-A and G-G are marked in the various views.

In FIG. 1, the cable 2 is shown in a state in which it is fully electrically and mechanically connected to the component 20. It may be seen that, in this state, the contact means 28 are inserted into the cable 20 and, in particular, into the electrical conductors 4 of the cable 20 in order to establish a secure mechanical and electrical contact. Clearly visible here, the contact means 28 have a tip 30 in order to be pierced into the conductors 4. The component 20 is designed here as a plug connector, possibly with a threaded screw connection arranged in the area 24, in order to be attached to a connection of a device such as a fieldbus module, actuator or sensor. This allows the cable 2 to be connected to the device for transmitting electrical energy and/or data via the plug connector.

In contrast to conventional solutions, the design of the cable 2 may significantly simplify the connection between component 20 and cable 2. For this purpose, structural additions may be made to the cable 2, such as, for example, at least one coding 50 formed spatially on the cable 2. In FIG. 1 it may be seen that the cable 2 has at least one cavity 6, which serves to form the at least one coding 50 on the cable 2 as further illustrated in FIG. 9 (see, for example, FIG. 9). Such a coding 50 may also be provided on the component 20 and then in particular be referred to as counter-coding 27 if this is formed complementary to the coding 50 on the cable 2. The coding of the cavity 6 means that a correspondingly counter-coded pin 26, preferably guide pin 26, may only be inserted into the cavity 6 as guide means 26 if the orientation of the component 20 relative to the cable 2 is correct (i.e. according to a lock-and-key principle). Otherwise, the insertion of the pin 26 into the cavity 6 may be prevented by other parts of the cable 2. This may then also block the establishment of the connection between cable 2 and component 20. The coding 50 on the cable 2 may thus specify a specific arrangement and assignment of electrical contact means 28 of the component 20 with the electrical conductors 4 of the cable 2.

The at least one coding 50 may comprise a mechanical and/or geometric coding 50 of the cable 2, in which a geometric profile 7 extends in the axial direction A of the cable 2. In FIG. 1 and FIG. 9, the profile 7 may be provided by a t-shaped opening of the cavity 6 on the cable 2 and a corresponding t-shaped counter-coding 27 may be provided on the component 20. The cavity 6 may also be designed to transmit a fluid, preferably a medium such as air or a liquid. In addition to a t-shaped coding, an L- or Y-coding or other forms are also conceivable.

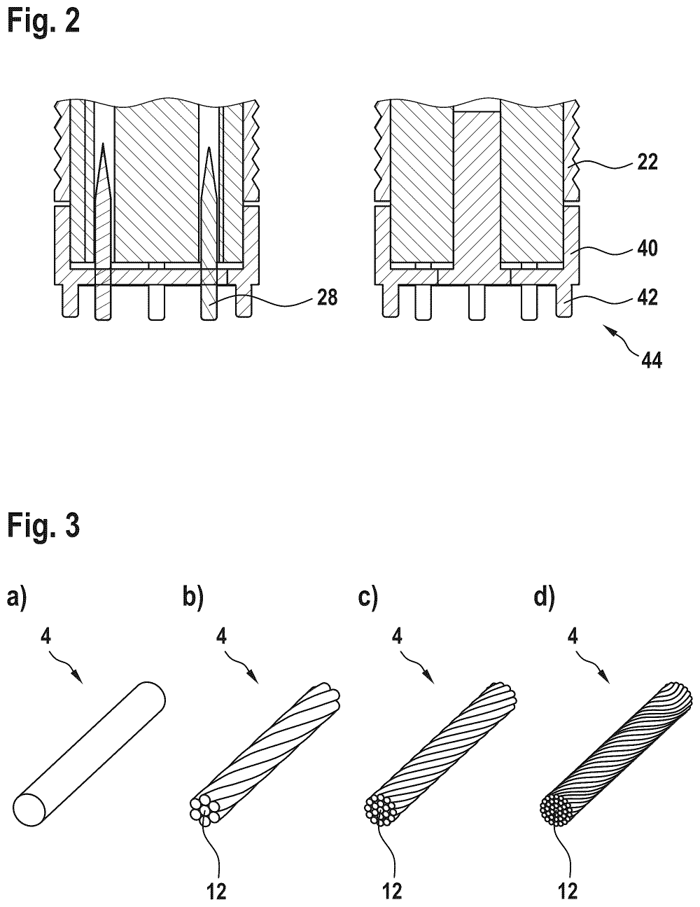

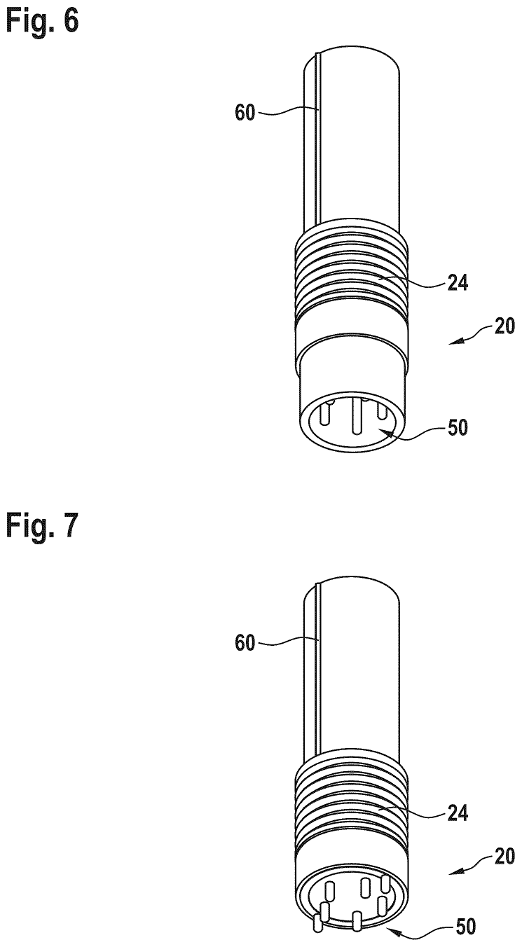

FIG. 2 shows an embodiment of the component 20 in the form of a plug connector, in which a protruding wall 40 is provided for connector assembly 40 (see also FIGS. 6 and 7). The wall 40 may, for example, be attached to a printed circuit board 42 of the component 20 in order to provide a locking device and/or anti-twist protection and/or a seal 44 on the cable 2. This wall 40 may optionally have a locking mechanism 22 to enable secure attachment to the cable 2.

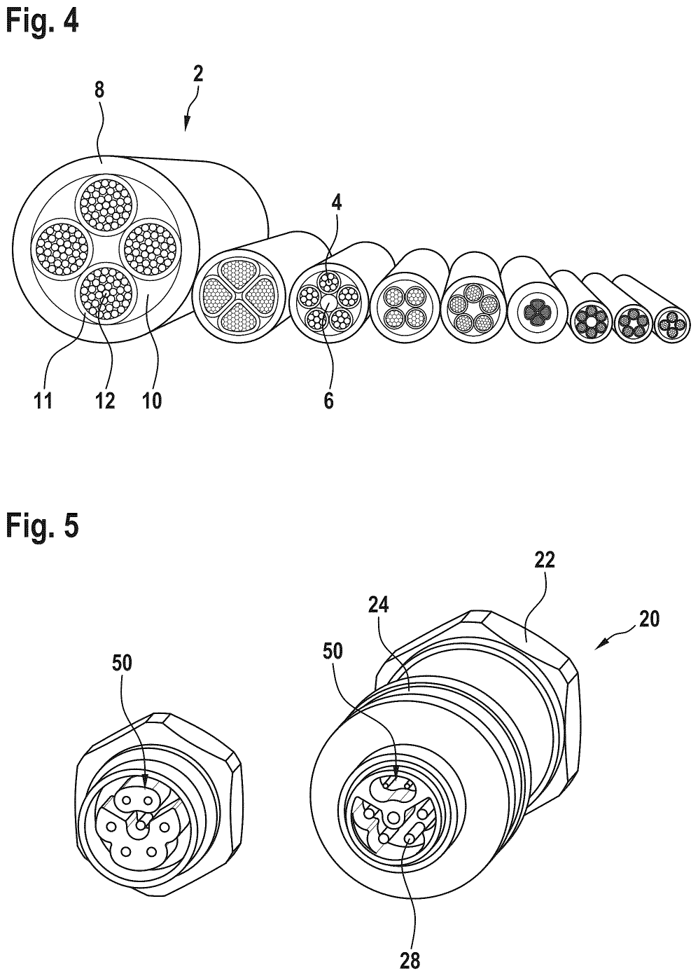

FIGS. 3 and 4 further illustrate that the cable may have the multiple conductors 4 in the form of strands, also referred to as stranded conductors. Each of these stranded conductors may have several fine, twisted wires 12, which may be surrounded by an insulating layer (insulation) recognizable in FIG. 4. This insulation is made, for example, from materials such as polyethylene or polyvinyl chloride. It may serve to insulate the conductors 4 both from each other and from the external environment. In addition, the insulation may often be color-coded to make it easier to identify and wire. In order to minimize electromagnetic interference, a shield made of a metal mesh or metal foil may be provided around the insulated conductors 4 as filling material 10. Furthermore, an additional inner sheath may be placed around the shielding to increase the mechanical stability of the cable 2. Furthermore, the entire cable 2 may have a robust outer sheath 8, which is preferably made of materials such as PVC, PE or thermoplastic elastomer and may have special properties such as flame resistance or oil resistance. This multi-layered structure allows the cable 2 to be highly flexible and robust, making it suitable for a wide range of applications.

In further optional designs of the cable 2, the conductors may be highly flexible and provided with 360° full shielding. This full shielding serves to effectively shield electromagnetic interference (EMC) and thus ensure the integrity of the data transmission. Other optional versions include overmoulded versions of the cable 2 with highly resistant PUR overmoulding, which are specially designed for use in harsh environments. The cables may be designed to be self-assembled, i.e. assembled in the field (on site at the system). In particular, this means that the cables themselves have the structural adaptations that allow them to be connected and disconnected quickly and easily and adapted to a desired length. In this way, the cables may be quickly adapted or replaced as required without the need for special tools or specialist knowledge.

The electrical conductor 4 may be made of copper or aluminum, for example. Other materials such as gold, silver, carbon fiber and conductive polymers may also be used as a component of the conductor 4, depending on the application. In addition, composite materials made from various of these elements may also be used in specialized applications in order to optimize specific properties such as conductivity, weight and corrosion resistance.

Further, the at least one coding 50 may comprise a geometric and/or extruded profile 7 of the cable 2 and/or a conduit (not explicitly shown) and/or a grommet. The at least one coding 50 may further comprise an electrical coding 50 of the cable 2, in which a systematic arrangement of the electrical conductors 4 of the cable 2 is provided, so that a specific assignment of the electrical contact means 28 of the component 20 is predetermined for the connection. In FIG. 5, a corresponding coding 50 is illustrated, in which the contact means 28 of the component 20 are arranged in a corresponding manner with different lateral spacings.

In FIGS. 1, 2 and 5-8, a component 20 for connection to an electrical cable 2 is shown schematically. The component may have at least one electrical contact means 28 for making electrical contact with at least one electrical conductor 4 of the cable 2 in an axial direction A of the cable 2 or conductor 4. The axial direction A, or longitudinal direction of the cable 2, is illustrated in FIG. 1 by a vertical arrow. Furthermore, the at least one electrical contact means 28 may be designed to make the electrical contact in the electrical cable 2—i.e. in particular within the cable 2 or sheath 8.

FIGS. 6 and 7 further illustrate that a further structure such as a locking and/or orientation structure 60 may be provided, for example, to further simplify the correct alignment of the component 20 relative to the cable 2 during the connection. The structure 60 is formed, for example, as a groove or material recess on the component 20 and/or on the cable 2.

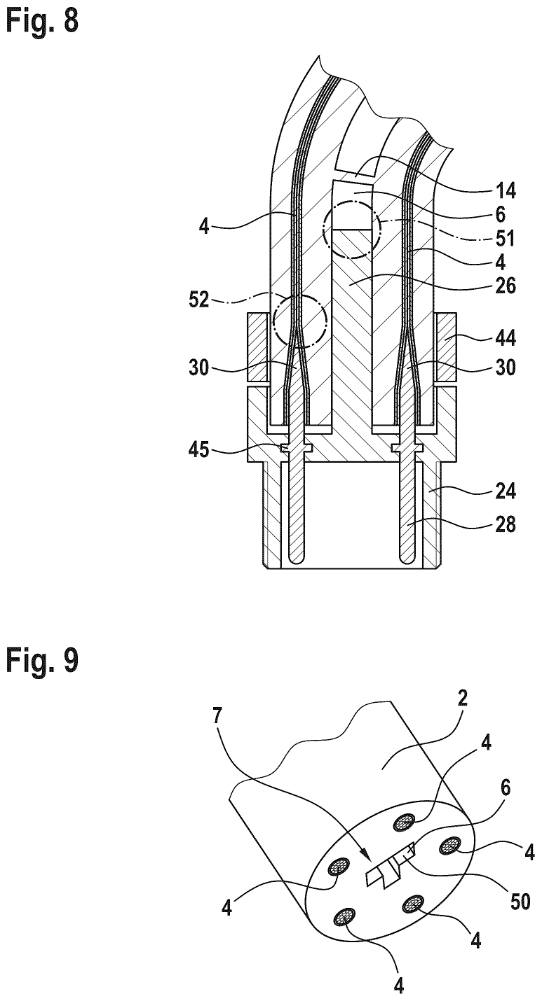

FIG. 8 shows that the cavity 6 of the cable 2 may also be interrupted by a connecting part 14. This connecting part 14 may repeatedly interrupt the cavity 6 in the axial direction A of the cable 2. In particular, it serves as a sealing for condensate. This has the advantage that moisture is prevented from penetrating the cable 2, thus ensuring that it remains functional. Accordingly, the connecting part 14 may also serve as a sealing element.

Furthermore, a locking pin 45 is shown in FIG. 8, which may be provided on the contact means 28 in order to fix the position on the cable 2 after the connection has been made. More generally formulated, a locking device 45 may be provided on the component 20 or on the cable 2 in order to fix the established connection.

It is further illustrated in FIGS. 8 and 9 that the coding 50 may comprise a first coding 51, which is provided by the shape of the cavity 6. This refers in particular to the shape of the opening of the cavity 6 with the profile 7 recognizable in FIG. 9. Alternatively or additionally, a second coding 52 may be provided, which is provided by the arrangement and/or formation of the conductors 4. In particular, the coding may be provided here by the formation of the strand 4 to the tip 30 of the contact means 28 or, conversely, the counter-coding may be provided by the formation of the tip 30 of the contact means 28 to the strand 4. Due to the tip 30, the contact means 28 may be designed accordingly as a needle, which then penetrates a conductor cross-section 5 of the conductor 4 for contacting during the connection (see FIG. 13). Different lengths of the contact means 28 may also be provided for a leading, e.g. of a safety contact means 29.

FIG. 8 further shows that the component 20 may comprise the at least one contact means 28 in the form of a piercing means, which is designed to be pierced into an electrical conductor 4 of the cable 2 in the form of an electrical strand 4 in the axial direction A of the cable 2 or the conductor 4. The bending apart of the single wires of the strand 4 at the pin tip 30 is illustrated in FIG. 8.

In FIG. 1 it is further illustrated by a dashed line that at least one of the contact means 28 may be designed as a safety contact means 29, which is designed to lead with regard to at least one or all of the other contact means 28. This allows the safety contact means 29 to contact one of the electrical conductors 4 of the cable 2 before the at least one or the other of the contact means 28 when the connection is made, i.e. during a contacting movement.

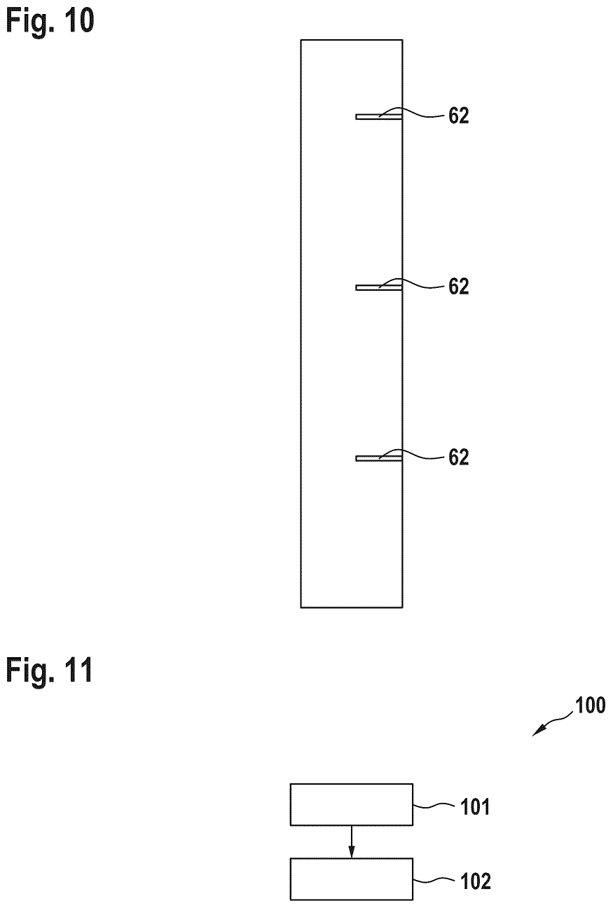

FIG. 10 shows that (e.g. every 5 mm) a recurring marking 62 may be provided on the cable 2, which indicates a depth of penetration of the electrical contact means 28, preferably in the form of piercing means. This marking 62 may be printed on, for example. The marking 62 may, for example, be provided in the form of a line or dot. The marking 62 may also be a mechanical marking which, for example, interacts with an insertion mechanism 80.

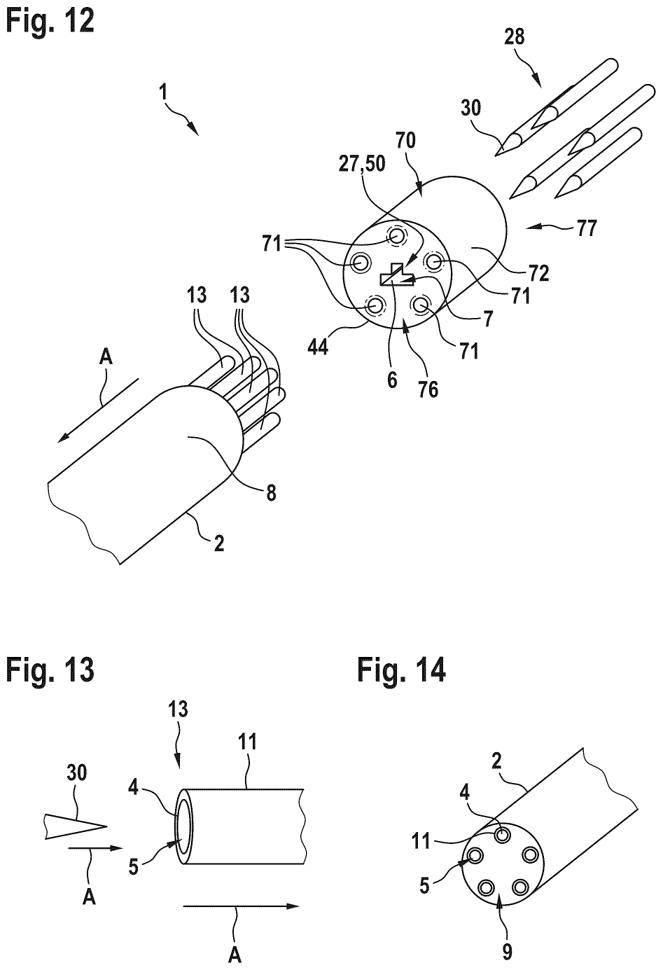

In FIG. 12, according to further embodiments of the invention, a connection system 1 with a component 20 and a cable 2 may be seen. The component 20 may be provided for connection to an electrical cable 2. For this purpose, the component 20 may comprise a plurality of contact means 28 for making contact with conductors 4 of the cable 2. In the electrical cable 2 shown, the conductors 4 may be accessible from the outside for contacting with the contact means 28. In FIG. 12, the conductors 4 are surrounded by an insulating sheath 11 and are thus part of lines 13, specifically stranded lines 13 (see FIG. 13). Both the contact means 28 and the conductors 4 are electrically conductive here. Furthermore, the conductors 4 may each have an exposed conductor cross-section 5 for contacting (see FIGS. 13 and 14).

The connection system 1 may be designed for contacting the contact means 28 with the conductors 4 in axial direction A of the cable 2 or conductor 4 in order to electrically connect the contact means 28 directly to the exposed conductor cross-sections 5. For this purpose, as illustrated in FIG. 13, the contact means 28 may each have a tip 30 and/or be needle-shaped. In other words, the conductors 4 may be contacted by piercing the contact means 28 through the exposed conductor cross-sections 5 in axial direction A.

In FIGS. 12 to 14, among others, a contact surface 9 is provided on the cable 2, at which the conductors 4 are accessible for contacting with the contact means 28. Specifically, the contact surface 9 may lie in a cut plane of the cable 2, which is created, for example, by cutting the cable 2 at this point. It may be seen that the conductors 4 there may be adjacent to the outside from an interior of the cable 2 (see FIGS. 13 and 14) or protrude (see FIG. 12) and are thus visible and accessible from outside the cable 2. In FIGS. 13 and 14, the respective exposed conductor cross-section 5 also lies in the sectional plane.

According to FIG. 13, the conductors 4 may each form a line 13 with a surrounding insulating sheath 11, whereby the lines 13 protrude from the contact surface 9 (see FIG. 12) or are flush with it (FIGS. 13 and 14). Furthermore, the solution according to embodiments of the invention may avoid stripping, so that the protruding conductors 4 and/or the exposed conductor cross-sections 5 are each still completely or partially surrounded by the insulating sheath 11. However, the protruding conductors 13 may be at least partially or completely freed from a cable sheath 8 of the cable 2 over the entire circumference (see FIG. 12).

The connection system 1 may have a guide device 70 shown in FIG. 12, which is formed separately from the cable 2 and the component 20 and/or is movably or detachably connected to the cable 2 and/or the component 20. The guide device 70 may be designed to mechanically guide the contacting in the axial direction A of the cable 2, and preferably to guide the conductors 4, in particular the lines 13, and/or the contact means 28 for contacting in the axial direction A of the cable 2. In other words, the guide device 70 may provide a linear guide for the cable 2 and/or the component 20. When the component 20 and the cable 2 move in a linearly guided manner relative to each other for contacting, this may also be referred to as a contacting movement.

The guide device 70 may have a guide housing 72 with a guide structure 71. In FIG. 12, the guide structure 71 is specifically provided in the form of openings of the guide housing 72 in order to provide the mechanical guide for the respective conductors 4, in particular cables 13, and/or contact means 28. As shown in FIG. 12, the guide structure 71 may be formed on a first side 76 of the guide housing 72 to receive the conductors 4, in particular cables 13, and may be formed on another, opposite second side 77 (facing away from the first side 76) of the guide housing 72 to receive the contact means 28.

The lines 13 in FIG. 12 may have different colors and thus be color-coded. Corresponding colors may also be provided in the area of the openings 71 to facilitate assignment.

Furthermore, at least one coding 50 or counter-coding 27 with the properties as described above may also be provided on the guide device 70, for example in the form of a guide grommet.

A part 44 of the component 20 and/or the guide device 70 in FIG. 12 may seal the contact surface 9 in the connected state and/or mechanically lock it and/or provide anti-twist protection. Here, for example, an O-ring or a sealing lip on the guide device 70 is conceivable as a sealing element. A latching lug (not explicitly shown) or a latching hook may serve as a locking element. A projection or a groove may serve as anti-twist protection.

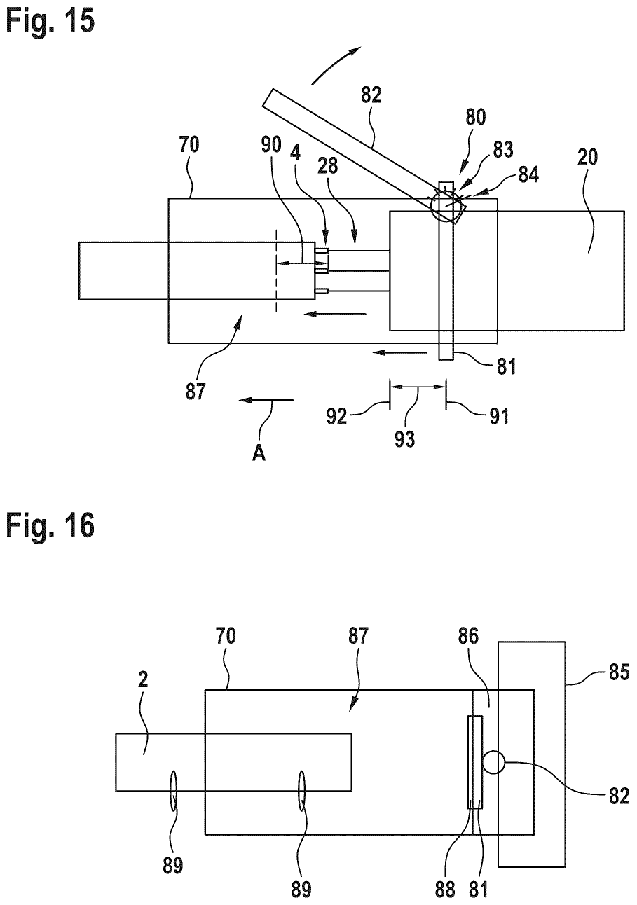

FIGS. 15 and 16 show an example of an insertion mechanism 80, which may be arranged on the guide structure 71 for controlling the contacting movement in order to insert the at least one or the multiple electrical contact means 28 into the associated electrical conductor 4 with a predetermined depth of penetration 90 in an axial direction A of the conductor 4 and/or the cable 2.

The insertion mechanism 80 may be designed to insert, in particular pierce, the respective contact means 28 linearly guided by the contacting movement into the associated electrical conductor 4 with the predetermined depth of penetration 90, in particular depth of piercing 90, the predetermined depth of penetration 90 preferably being in the range from 0.5 mm to 10 mm, preferably 1 mm to 6 mm, preferably 2 mm to 4 mm.

The insertion mechanism 80 may further comprise a pressure element 81 and a transmission arrangement 82. Here, the transmission arrangement 82 may be connected to the pressure element 81 in a force-transmitting manner in order to set the pressure element 81 in motion when force is applied manually or mechanically to the transmission arrangement 82. In this way, the respective electrical contact means 28 may be introduced, preferably pierced, into the associated electrical conductor 4 by the pressure element 81 via the contacting movement. Here, a travel 93 for the pressure element 81 between a starting position 91 and an end position 92 may be determined by the predetermined depth of penetration 90 and/or may be structurally predetermined. Furthermore, an adjusting mechanism 84 may be provided to adjust the predetermined depth of penetration 90 and preferably the travel 93 in the insertion mechanism 80, preferably depending on a cable type of the cable 2 and/or continuously and/or in several predefined stages.

Furthermore, FIG. 15 schematically illustrates that the insertion mechanism 80 may be configured as a lever mechanism 80 in which a transmission arrangement 82 comprises a lever arm 82. This may serve to transmit a manual or machine application of force to the transmission arrangement 82 into the controlled contacting movement, in which the control is such that the contacting movement is linearly guided and/or the depth of penetration 90 is predetermined and/or controlled and/or limited and/or the predetermined and/or a current depth of penetration 90 is indexed for a user.

Furthermore, an indexing device 83, also illustrated in FIG. 15, may be provided in order to visually or haptically or acoustically indicate a current depth of penetration 90 during the contacting movement.

FIG. 16 shows that the insertion mechanism 80 may also have a nut 85, preferably a union nut 85, which is designed to establish a mechanical connection between the component 20 and the cable 2 and to be screwed onto a thread 86 for this purpose. Furthermore, a transmission arrangement 82 may be provided, which is designed to transmit a movement, in particular a rotary movement, of the nut 85 on the thread 86 to a pressure element 81. Furthermore, the pressure element 81 may be arranged and guided in the region of a guide space 87 in order to move through the guide space 87 of the guide structure 71 by the transmitted movement along a longitudinal axis of the thread 86 in order to thereby exert a force for inserting the electrical contact means 28, wherein the guide space 87 is designed to receive a part of the component 20 and/or the at least one electrical contact means 28.

Furthermore, according to FIG. 16, a holding element 88 may be provided, which is firmly connected to the pressure element 81 in order to limit the contacting movement when the holding element 88 encounters a counter-holding element 89.

In FIG. 11, a method 100 for producing a connection of a cable 2 to a component 20 is schematically visualized. According to a first method step 101, a connection system 1 with a cable 2 and a component 20 may be provided, wherein the cable 2 has several electrical conductors 4. A respective conductor cross-section 5 of the conductors 4 may be exposed and accessible from the outside. Furthermore, the component 20 may comprise a plurality of contact means 28 for contacting the conductors 4 of the cable 2. According to a second method step 102, the contact means 28 may be inserted into the conductors 4 in the axial direction A of the cable 2 through the exposed conductor cross-sections 5 in order to establish contact between the contact means 28 and the conductors 4.

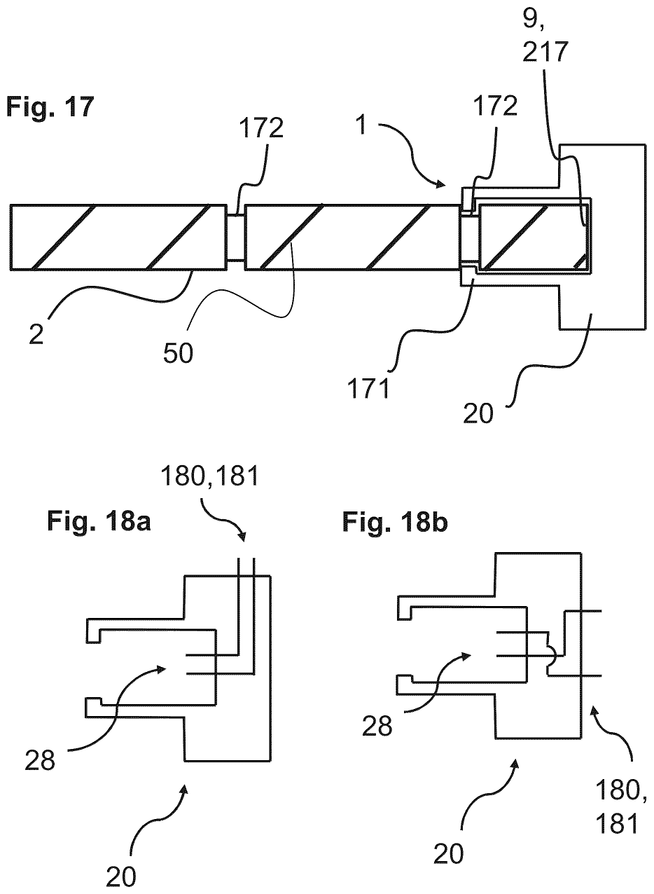

FIG. 17 schematically shows an embodiment of the connection system 1 according to the invention, which comprises an embodiment of the component 20 according to the invention and an embodiment of the cable 2 according to the invention. The cable 2 has a plurality of mutually spaced strain relief contours 172. The strain relief contours 172 are formed as circumferential grooves and are evenly spaced apart along the cable 2. A strain relief 171 of the component 20 engages in such a strain relief contour 172, wherein the strain relief 171 is formed in one piece with the component 20 and prevents that an accidental pulling on the cable 2 leads to an unintentional release of the electrical connection between the cable 2 and the component 20. The electrical connection is established by means of pointed contact means, each of which is pierced into only one predetermined electrical conductor of the cable. The electrical conductors of the cable 2 extend twisted to one another along the length of the cable 2. The cable 2 also has a coding 50 which interacts with a counter-coding of the component 20 in such a way that the contact means of the component 20 only come into electrical contact with the electrical conductors provided for this purpose during the establishment of the electrical connection between the component 20 and the cable 2, in that the coding 50 and the counter-coding together form a guide and prevent any other contact between the conductors of the contact means. For this purpose, the coding 50 of the cable 2 is formed on the circumference of the cable as a helical or threaded groove running in the direction of extension of the cable 2. Alternatively, instead of a groove, an analogously designed bead may be provided. The coding 50 has a continuous course along the direction of extension of the cable 2 and has the same relative position to the electrical conductors of the cable 2 at every point along the extension of the cable 2, transverse or perpendicular to the direction of extension of the cable 2. In other words, the cable 2 may be shortened to a desired length at any point of the cable 2 in order to establish an electrical connection between the cable 2 and the component 20, since the constant relative position along the cable ensures the intended electrical contacting. The contact surface 9 is formed at the cable end 217, at which the contact means are pierced into the conductors of the cable.

FIG. 18a shows a schematic embodiment of the component 20 according to the invention. The contact means 28 for contacting the electrical conductors of the cable may be seen. The contact means 28 lead electrically to contact conductors 180 of a plug 181 of the component 20, where the contact conductors 180 form a plug assembly 181. The course of the guide from the contact means 28 to the contact conductors 180 of the plug 181 is not formed in a straight line, but is angled at least once, preferably vertically, whereby the plug 181 is formed on a side of the component 20 that extends transversely or perpendicularly to the insertion direction of the cable 2. Instead of a plug 181 with a plug assembly 181, a socket with a socket assembly may be provided.

FIG. 18b shows a further schematic embodiment of the component 20 according to the invention, which differs from the embodiment of FIG. 18a in that the plug 181 is formed on a side of the component 20 that faces away from the side of the component 20 on which the cable may make electrical contact with the contact means 28. In addition, the course of the guide from the contact means 28 to the contact conductors 180 of the plug 181 is formed in such a way that the arrangement and/or assignment of the contact conductors 180 of the plug 181 differs from that of the contact means 28.

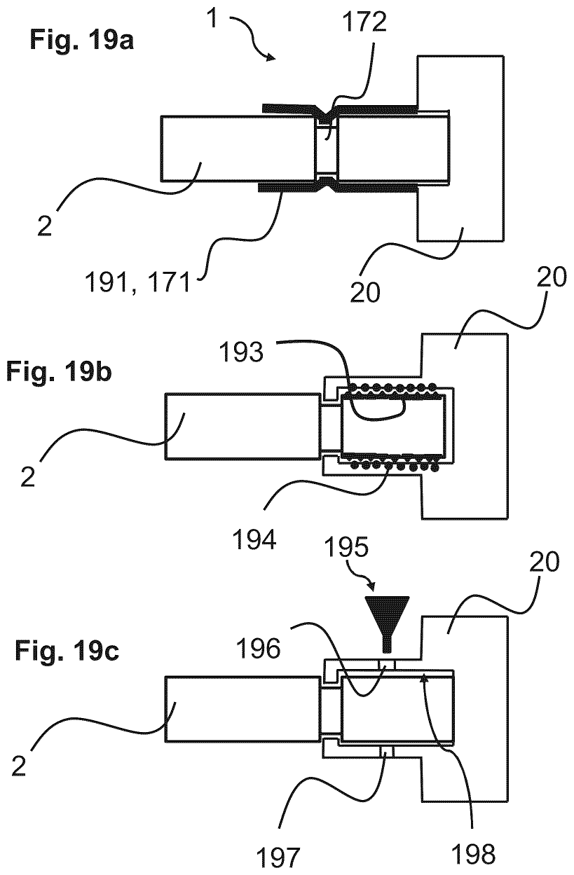

FIG. 19a shows an embodiment of a connection system 1. Here, a strain relief 171 is formed by means of a heat-shrink tubing 191. The heat-shrink tubing 191 also serves to seal the electrical connection between the cable 2 and the component 20. The heat-shrink tubing 191 engages in a circumferential groove that forms the strain relief contour 172. In addition, the heat-shrink tubing is attached to the component 20.

FIG. 19b shows a further embodiment of a connection system 1. Here, the cable 2 has a microencapsulation 193 which, on contact with an activation substance 194, releases a sealing compound which seals the electrical connection between the cable 2 and the component 20 to the environment. Of course, it is also possible that the component 20 has the microencapsulation while the cable 2 has the activation substance. Alternatively, it is also conceivable that the activation, i.e. the release of the microencapsulation, takes place by means of heat or light or radiation or in another suitable manner.

FIG. 19c shows a further embodiment of a connection system 1. Here, a sealing chamber 198 in the component, which is bounded by the cable 2 and the component 20, is sealed to the environment by means of a sealing compound 195. Preferably, the component 20 has a filler opening 196 for filling the sealing compound 195. Furthermore, the component 20 may have an outlet opening 197, from which the filled sealing compound 195 may escape if the sealed chamber 198 is already filled with the sealing compound 195. Alternatively or additionally, it is possible that the component 20 has a viewing window which delimits the sealing chamber 198, whereby a degree of filling of the sealing chamber 198 by means of the sealing compound 195 may be visually identified by a user.

The contact means are not shown in FIGS. 17 and 19a to 19c for ease of representation or are not visible due to the chosen representation.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System, connection system
2 cables
4 Core, strand, conductor
6 Cavity
7 Profile
8 Sheath, cable sheath
9 Contact surface, cut surface
10 Filling material
12 Single wire
14 Sealing for condensate
20 Component
22 Locking, unlocking
24 Threaded screw connection
26 Guide, guide means
27 Counter-coding
28 Contact means, pin
29 Safety contact means
30 Pin tip
40 Connector assembly
42 Printed circuit board
44 Locking device, anti-twist protection, seal
45 Locking pin
50 Coding
51 First coding
52 Second coding
60 Structure
62 Depth marker
70 Guide device
71 Guide structure
72 Guide housing
76 First side
77 Second side
80 Insertion mechanism
81 Pressure element
82 Transmission arrangement
83 Indexing device, indexing
84 Adjusting mechanism
85 Nut
86 Thread
87 Guiding space
88 Holding element
89 Counter-holding element
90 Depth of penetration
91 Starting position
92 End position
92 Travel
100 Method
101 First process step
102 Second process step
A Axial direction
217 Cable end
171 Strain relief
172 Strain relief contour
180 Contact conductor
181 Plug, plug assembly
191 Heat-shrink tubing
193 Microencapsulation
194 Activation substance
195 Sealing compound
196 Filler opening
197 Outlet opening
198 Sealed chamber

1. A connection system, comprising:
a component for connection to an electrical cable, the component comprising a plurality of contact means for making contact with conductors of the cable, the contact means being electrically conductive,
the electrical cable, in which the conductors are accessible for contacting with the contact means, wherein the conductors are electrically conductive, and wherein the conductors each have an exposed conductor cross-section,
characterized in
that the connection system is designed for contacting the contact means with the conductors in an axial direction of the cable in order to electrically connect the contact means directly to the exposed conductor cross-sections.

2. The connection system according to claim 1,
characterized in that the contact means each have a tip and/or are needle-shaped in order to contact the conductors by piercing the contact means on and/or through the exposed conductor cross-sections in the axial direction.

3. The connection system according to claim 2,
characterized in that the conductors are each formed as a strand, each of which has flexible single wires in order to electrically conductively surround the contact means pierced through the respective conductor cross-section.

4. The connection system according to claim 1,
characterized in that the contact means are designed to be introduced, preferably pierced, into the conductors at and/or through the exposed conductor cross-sections, the respective conductor with its exposed conductor cross-section and the preferably pierced contact means introduced therein being at least partially surrounded by an insulating sheath.

5. The connection system according to claim 1,
characterized in that a contact surface is provided in the cable, at which the conductors are accessible for contacting with the contact means, the contact surface lying in a sectional plane of the cable, at which the conductors adjoin or protrude outwards from an interior of the cable and are visible from outside the cable, wherein the conductors preferably protrude from the contact surface or lie in a recessed position in the cable, or wherein the respective exposed conductor cross-section also lies in the cutting plane.

6. The connection system according to claim 5,
characterized in that the conductors each form a line with a surrounding insulating sheath, the lines protruding from the contact surface, the lines being only partially surrounded by a cable sheath of the cable, wherein the protruding conductors and/or the exposed conductor cross-sections are each completely or partially surrounded by the insulating sheath, wherein the contact surface is formed by a cut surface of the cable sheath of the cable.

7. The connection system according to claim 1,
characterized in that a geometric profile, in particular a spatial shape and/or contour, extends in the axial direction of the cable, the profile defining a guide cavity for a guide means and preferably for a guide pin of the component in order to mechanically guide the contacting in the axial direction of the cable, preferably to guide the insertion of the contact means into the conductors in the axial direction of the cable, wherein the guide cavity is particularly preferably designed to transmit a fluid, in particular to transmit a medium such as air or a liquid.

8. The connection system according to claim 1,
characterized in that the connection system has a guide device which is formed separately from the cable and the component and/or is movably connected to the cable and/or the component, and is designed to mechanically guide the contacting in the axial direction of the cable, and preferably to guide the conductors, in particular the lines, and/or the contact means for contacting in the axial direction of the cable.

9. The connection system according to claim 8,
characterized in that the guide device has a guide housing with a guide structure, preferably in the form of openings in the guide housing, in order to provide the mechanical guide for the respective conductors, in particular lines, and/or contact means, the guide structure being designed to accommodate the conductors, in particular lines, on one side of the guide housing and on another side of the guide housing, preferably opposite in the axial direction of the guide device, for receiving the contact means, in particular in order to provide the contacting in an interior space of the guide housing of the guide device and/or in order to mechanically guide an insertion of the contact means into the conductors in the axial direction of the cable for contacting.

10. The connection system according to claim 8,
characterized in that the conductors each form a line with a surrounding insulating sheath, the lines being color-coded, in particular by a different color of the insulating sheaths, a corresponding counter-coding being provided on the guide device in order to assign a guide structure and preferably openings of the guide housing to the corresponding lines in terms of color.

11. The connection system according to claim 8,
characterized in that at least one coding is formed spatially on the cable and/or on the guide device in order to predetermine a specific arrangement and assignment of the contact means of the component with the electrical conductors of the cable, the at least one coding comprising a mechanical and/or geometric coding of the cable and/or of the guide device in which a geometric profile, in particular a spatial shape and/or contour, extends in the axial direction of the cable and/or the guide device, the profile preferably defining a guide cavity for a guide means and preferably for a guide pin of the component, so that a specific orientation of the component is predetermined for the connection, in order to block the connection of the component in the event of a deviation from the specific orientation, wherein the guide cavity is particularly preferably designed for transmitting a fluid, in particular for transmitting a medium such as air or a liquid, wherein the at least one coding is preferably a geometric and/or extruded profile of the cable and/or the guide device, in particular in the form of a grommet, and/or a hose, wherein the at least one coding preferably additionally comprises an electrical coding and/or color coding, in which a systematic arrangement of the electrical conductors of the cable is provided, so that a specific assignment of the electrical contact means of the component is predetermined for the connection.

12. The connection system according to claim 11,
characterized in that the at least one coding is formed by means of a rotationally symmetry-free cross-section of the cable, in particular by a rotationally symmetry-free inner and/or outer contour of the cable.

13. The connection system according to claim 8,
characterized in that the conductors of the cable are each formed as strands in order to form a receptacle for inserting the contact means of the component, preferably for piercing the contact means in the form of a contacting tip into the strands in the axial direction of the cable, the guide device being provided between the cable and the component in order to guide the insertion and preferably piercing with a predetermined arrangement and assignment of the contact means of the component with the conductors of the cable, a complementary counter-coding of the component being provided for the coding on the cable and/or the guide device in order to predetermine the guide and preferably an alignment of the cable in relation to the component.

14. The connection system according to claim 1,
characterized in that the component and/or a guide device rests directly against the contact surface in the connected state, wherein the contact means of the component contact the conductors of the cable and are preferably inserted therein, preferably pierced, wherein a part of the component and/or the guide device seals the contact surface in the connected state and/or mechanically locks it and/or provides an anti-twist protection.

15. The connection system according to claim 1,
characterized in that the electrical conductors only and/or directly extend and/or adjoin a or the contact surface of the cable, preferably in order to enable piercing of the contact means, in particular in the form of contacting tips and/or piercing means, into the electrical conductors at the contact surface,
that the contact surface preferably extends transversely, in particular perpendicularly, to the direction in which the cable extends,
and in that, in particular, the contact surface forms a cut surface of the cable, at which the cable has preferably been shortened to a desired length, and/or a cable end of the cable.

16. The connection system according to claim 1,
characterized in that the electrical conductors of the cable are twisted together, in particular in the form of one or more twisted pairs, twisted threes or twisted fours, in that the at least one coding has a continuous course along the length of the cable and a course which is matched to the twisting in such a way that at each point of the cable along the length of the cable the at least one coding and the electrical conductors have the same relative position to one another, in particular in a plane transverse, preferably perpendicular, to the direction in which the cable extends.

17. The connection system according to claim 1,
characterized in that the cable has a fluid line, in particular a liquid line or gas line, that in particular the at least one coding is formed partially or only by means of the fluid line,
in that the electrical conductors, in particular the stranding or strandings, surround the fluid line along the extent of the cable in order to preferably ensure uniform cooling of the conductors by means of the fluid which may be conducted through the fluid line,
in that the component has a fluid channel which is connected in a fluid-transmitting manner to the fluid line of the cable and in particular forms a counter-coding in part or only in part.

18. The connection system according to claim 1,
characterized in that the cable has along its extension on its outer circumference, preferably at regular intervals from one another, strain relief contours, particularly preferably in the form of circumferential recesses, in particular grooves or notches, or elevations, in particular beads or steps, preferably for a heat-shrink tubing or a strain relief, and
in that the component has a strain relief, in particular a heat-shrink tubing formed as a strain relief, which is preferably attached to the component, for the cable, which cooperates with the strain relief contour of the cable in such a way, that the cable is strain-relieved by the strain relief forming a form-fit in particular with the strain relief contour of the cable, preferably by the strain relief engaging behind the strain relief contour or engaging in the strain relief contour.

19. The connection system according to claim 1, characterized in that the plurality of contact means, in particular the configuration and/or arrangement and/or dimensioning of the plurality of contact means, are designed for the electrical conductors, in particular the dimensioning and/or the course of the electrical conductors and/or the arrangement of the electrical conductors on the contact surface, that an electrical contacting of several electrical conductors by means of only one of the contact means, in particular by one of the contact means electrically contacting a first electrical conductor in the contact surface and a further electrical conductor in the direction of extension of the cable behind or next to the first electrical conductor, preferably due to the twisting of the electrical conductors, is excluded.

20. The connection system according to claim 1, characterized in that the contact means lead electrically to electrical contact conductors of a plug assembly or socket assembly of the component, in that the position and/or arrangement and/or assignment and/or dimensioning of the electrical contact conductors differs from that of the contact means, in particular on the contact surface.

21. The connection system according to claim 1, characterized in that an electrical connection is established between the cable and the component, in particular in that the contact means are pierced into associated conductors, in that the connection system comprises a seal, in particular a material-fit and/or force-fit and/or form-fit seal, which seals the connection and in particular a cable section adjacent to the connection from an environment of the connection system, in particular in accordance with IP20 or IP67,
that the seal is preferably formed, in particular in the case of a form-fit seal, by means of a heat-shrink tubing or the heat-shrink tubing forming the strain relief.

22. The connection system according to claim 21, characterized in that the seal is formed by means of a sealing compound, in particular adhesive or casting compound,
in that, in particular in the direction in which the cable extends and/or perpendicular to the direction in which the cable extends, a sealing chamber for receiving the sealing compound is formed between the cable, in particular the contact surface of the cable, and the component, in which the sealing compound is located and preferably completely fills the sealing chamber, the sealing chamber preferably having a filler opening for the sealing compound, which is in particular closed by the sealing compound,
in that the sealed chamber preferably has an outlet opening for the sealing compound, which is closed in particular by the sealing compound,
in that in particular a section of the component delimiting the sealed chamber is formed from a transparent material so that the degree of filling of the sealed chamber with the sealing compound may be determined optically.

23. The connection system according to claim 21, characterized in that the seal is formed by means of a released content of a microencapsulation, in particular of the cable or the component.

24. The connection system according to claim 21, characterized in that the seal seals and/or electrically insulates a transition from the fluid line to the fluid channel in a fluid-tight manner with respect to the contact points, which are formed by means of contactings of the conductors with the contact means on the contact surface, and/or wherein the seal electrically insulates and/or seals the contact points, which are formed by means of contactings of the conductors with the contact means on the contact surface, with respect to one another.

25. The connection system according to claim 1, characterized in that an attachment of the cable to the component is formed by means of a force-fit and/or form-fit and/or material-fit connection.

26. The connection system according to claim 1, characterized in that the connection system comprises an insertion mechanism, in particular a screw mechanism, a lever mechanism or a plug-in mechanism, in order to carry out the contacting movement, the insertion mechanism preferably being designed to move the cable in the direction of the component during the contacting movement, the connection system or the insertion mechanism preferably comprising an adjusting mechanism for setting a predetermined depth of penetration of the contact means into the conductor at the insertion mechanism, preferably as a function of a cable type of the cable and/or continuously and/or in several predefined stages, wherein the connection system or the insertion mechanism preferably has an indexing means which is designed to index the current depth of penetration for a user during the contacting movement.

27. A cable for connection to a component, the cable having a plurality of electrical conductors, the conductors each having an exposed conductor cross-section for electrical contacting with contact means of the component,
characterized in
that the cable is designed to provide the contacting with a movement of the conductors and the contact means relative to one another parallel to an axial direction of the cable in order to electrically connect the contact means directly to the exposed conductor cross-section.

28. The cable according to claim 27,
characterized in that the cable, in particular on the outer circumference of the cable and/or on the contact surface, has a microencapsulation for forming a seal, the contents of the microencapsulation being releasable in particular by the supply of heat, radiation, in particular the supply of light, preferably in the form of ultraviolet light, contact with an activation substance or the supply of light in combination with moisture, or
in that the cable has, in particular on the outer circumference and/or on the contact surface, an activation substance for a microencapsulation in order to release the contents of the microencapsulation on contact with the latter in order to form a seal.
